(19) United States
(12) Patent Application Publication
(10) Pub. No.: US 2002/0078092 A1
(43) Pub. Date: Jun. 20, 2002

(54) System and method for reformatting contents in wireless internet site

(76) Inventor: Minhoe Kim, Seoul (KR)

Correspondence Address: Mr. Marc D. Machtinger, Esq., Law Office of Marc D. Machtinger, Ltd., 750 W. Lake Cook Road, Suite 350, Buffalo Grove, IL, 60089-2073, US

(21) Appl. No.: 09/917,281

(22) Filed: Jul. 27, 2001

(30) Foreign Application Priority Data
Jul. 28, 2000 (KR) 2000-43569
Oct. 17, 2000 (KR) 2000-60863
Dec. 23, 2000 (KR) 2000-81011

(51) Int. Cl. G06F 17/00

(52) U.S. Cl. 707/513

(57) ABSTRACT

Disclosed is a system and method for reformatting contents in a wireless Internet site in which an XML-based meta tag is specified in consideration of an Internet site-building tag according to each wireless protocol, and, on the basis of this, a wireless Internet site made with a wireless Internet or a meta tag is converted to conform to the form of a proper tag according to the type of a browser of a wireless terminal which accesses the wireless Internet site, and then is transmitted to the wireless terminal. According to the present invention, multimedia contents used in a wired or wireless Internet site is converted to conform to a multimedia service that can be recognized by a wireless terminal which accesses the wireless Internet site and then is transmitted to the wireless terminal so that a user can be, at more rapid transmission rate, supplied with multimedia information such as graphic images, moving pictures, sound, etc.

### BACKGROUND OF THE INVENTION

1. Field of the Invention

The present invention relates to a system and method for reformatting contents in a wireless Internet site, and more particularly, a system and method for reformatting contents in a wireless Internet site in which an XML-based meta tag is specified in consideration of an Internet site-building tag according to each wireless protocol, and, on the basis of this, a wireless Internet site made with a wireless Internet or a meta tag is converted to conform to the form of a proper tag according to the type of a browser of a wireless terminal which accesses the wireless Internet site, and then is transmitted to the wireless terminal.

2. Description of the Related Art

Currently, wireless Internet sites are actively built, but wireless protocols supported for the purpose of building of the wireless Internet sites are different according to network business enterprises or wireless terminals. For this reason, in the case of building the wireless Internet site, in order to support all of the different wireless protocols, the wireless Internet site should be built by each wireless protocol, which requires much time and cost.

A conventional method for constructing a wireless Internet site is largely classified into three methods. First, a wireless Internet site is built individually according to each wireless protocol. Second, by means of automatic conversion software, a Web site which had been built previously is converted into a wireless Internet site. Third, by means of semi-automatic conversion software, only a desired part is extracted from a Web site which had been built previously so that the extracted Web site part is converted to build a wireless Internet site.

However, such conventional wireless Internet site building methods have the following drawbacks.

(a) In the case of building an individual wireless Internet site according to each wireless protocol, the most proper wireless Internet site can be built for each wireless protocol. However, if the number of wireless protocols is N, the period of time required to develop respective individual wireless Internet sites for the N wireless protocols is N times as large as that required to develop one wireless Internet site for one wireless protocol. In practice, where N wireless Internet sites according to the N wireless protocols are built, they can be managed commonly under the control of a processor. But, the time required to process all the interfaces for the N wireless Internet sites is increased by N times as compared with that required to process one interface for one wireless Internet site. Also, to fully know each of the N wireless protocols correctly, one must be an expert for each wireless protocol.

In addition, in terms of maintenance and repair, where there is needed a modification, since all the wireless Internet sites built individually must be serviced, more time and cost is required accordingly, and it is not assured that all the wireless Internet sites are corrected uniformly.

(b) In the case of building a wireless Internet site by using automatic conversion software, the size of a screen for the contents of sites to be displayed, the amount of the contents, graphic images and sound cannot be converted completely between an existing HTML-based Web site and a wireless Internet site. Further, more recently, a variety of Web sites employing a flash technology are developed successively, which acts as a factor that makes automatic conversion between the existing HTML-based Web site and the wireless Internet site impossible.

This method has an advantage that a wireless Internet site does not need additional building, but has a great disadvantage that the wireless Internet site cannot be readily built as desired and an HTML-based Web site must necessarily be made prior to building the wireless Internet site.

(c) In the case of building a wireless Internet site by using semi-automatic conversion software, only a desired part is extracted from among the contents of a pre-built Web site to build a wireless Internet site. However, in terms of the details of contents, there is a distinct difference between wired and wireless Internet sites. Accordingly, in the case that one of the wired and wireless sites is displayed on a screen, it may be deteriorated in quality of image. Also, as described previously, Web sites employing a flash technology cannot be easily converted into wireless Internet sites, and the Web sites must necessarily be made prior to building the wireless Internet sites.

### SUMMARY OF THE INVENTION

Therefore, the present invention has been made in view of the above-mentioned problems, and it is an object of the present invention to provide a system and method for reformatting contents in a wireless Internet site in which an XML-based meta tag is specified in consideration of an Internet site-building tag according to each wireless protocol, and, on the basis of this, a wireless Internet site made with a wireless Internet or a meta tag is converted to conform to the form of a proper tag according to the type of a browser of a wireless terminal which accesses the wireless Internet site, and then is transmitted to the wireless terminal.

It is another object of the present invention to provide a system and method for reformatting contents in a wireless Internet site in which a national language used to draw up the contents of the wireless Internet site is identified, and the contents is translated from the identified national language into a national language supported by a wireless terminal which accesses the wireless Internet site according to a result of an identification of the national language, and then is transmitted to the wireless terminal.

It is another object of the present invention to provide a system and method for reformatting contents in a wireless Internet site in which multimedia information used in a wired or wireless Internet site is converted to conform to a multimedia service supported by a wireless terminal which accesses the wireless Internet site and then is transmitted to the wireless terminal.

According to an aspect of the present invention, there is provided a system for reformatting contents in a wireless Internet site which converts the wireless Internet site to conform to the form of a proper tag according to the type of a browser of a wireless terminal which accesses the wireless Internet site for transmission to the wireless terminal, comprising:

a message-receiving section adapted to receive a message from the wireless terminal and check a language supported by the wireless terminal from the received message to store it therein;

an external processor adapted to provide contents over a wireless Internet;

an external processor-communicating section adapted to determine which Web page has been called from the received message to call a corresponding external processor and to allow contents data processed by and outputted from the called external processor to be received therethrough;

a message-checking section adapted to determine whether or not the contents data inputted thereto through the external processor-communicating section from the external processor is configured to conform to a meta tag as a pre-defined language;

a contents-reformatting section adapted to convert the contents data into a language supported by the wireless terminal if it is determined that the contents data is configured with the meta tag; and

a message-transmitting section adapted to transmit converted contents applied thereto from the contents-reformatting section to the wireless terminal.

Preferably, the contents-reformatting section further includes a tag-converting module adapted to convert an input message identified by the message-checking section into contents of an XML-based meta tag (MML) type and then converts the converted MML-type contents into contents of type which can be recognized by the wireless terminal, and additionally also includes a language-translating module adapted to analyze a header portion of the contents and a header portion of the message requested by the wireless terminal to identify a national language used to draw up the contents and translate the contents into a national language supported by the wireless terminal according to a result of the identification of the used national language, and/or a multimedia-converting module adapted to identify a used multimedia form using the header portion of the request message of the wireless terminal and convert multimedia contents inputted to the contents-reformatting section from the external processor into a multimedia form supported by the wireless terminal according to a result of the identification of the used multimedia form.

According to another aspect of the present invention, there is also provided a method for reformatting contents in a wireless Internet site which converts the wireless Internet site into a proper language according to the type of a browser of a wireless terminal which accesses the wireless Internet site for transmission to the wireless terminal, comprising the steps of:

receiving a message requesting a provision of a Web page from a wireless terminal;

identifying which protocol is used in the wireless terminal;

calling a corresponding external processor on the basis of various factors inputted to a contents-reformatting system from the wireless terminal;

allowing the called corresponding external processor to process associated contents on the basis of the various factors, and then to transmit the resultant contents with one of a plurality of Internet languages to the external processor-communicating section;

determining whether or not the resultant contents conforms to a grammar of each language according to a DTD document defined by the message-checking section when the message-checking section receives the resultant contents configured with a language from the called external processor through the external processor-communicating section;

identifying a national language used in the wireless terminal by using an HTTP header of an input message of the wireless terminal;

determining whether or not there is an element for identifying a national language used to draw up the message requested by the wireless terminal or the received resultant contents in a header of the request message of the wireless terminal or a header of the received resultant contents;

loading a language-converting form basically set in an environmental parameter if it is determined that there is not an element for identifying the used national language;

determining whether or not a national language supported by the wireless terminal is identical with that used to draw up the contents if it is determined that there is an element for identifying the used national language;

translating the contents into a national language supported by the wireless terminal if it is determined that the national language supported by the wireless terminal is not identical with that used to draw up the contents;

identifying a protocol used in the wireless terminal using a contents type of the input message if it is determined that the national language supported by the wireless terminal is identical with that used to draw up the contents;

determining whether or not a protocol of the wireless terminal is identical with that of contents of the input message;

loading a style sheet for converting the protocol of the contents into MML if it is determined that the protocol of the wireless terminal is not identical with that of contents of the input message;

converting the received contents into the MML on the basis of the style sheet;

loading a style sheet for converting the MML into the protocol of the wireless terminal;

converting the MML into a target protocol on the basis of the style sheet; and

transmitting completed contents to the wireless terminal requesting the provision of the Web page.

Preferably, the step of allowing the called corresponding external processor to process associated contents, and then to configure the resultant contents with one of a plurality of Internet languages for transmission to the external processor-communicating section further includes the steps of:

determining whether or not the resultant contents configured with a language that have been transmitted to the external processor-communicating section are general texts;

identifying a multimedia form used in the wireless terminal by using an HTTP header of an input message of the wireless terminal if it is determined that the resultant contents transmitted to the external processor-communicating section are not general texts;

determining whether or not a multimedia form of the wireless terminal is identical with that of the resultant contents;

converting multimedia contents inputted to the message-checking section from the external processor to conform to a multimedia form of the wireless terminal if it is determined that the multimedia form of the wireless terminal is not identical with that of the resultant contents.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating a system for reformatting contents in a wireless Internet site according to the present invention;

FIG. 2 is a block diagram illustrating a system for reformatting contents in a wireless Internet site according to one embodiment of the present invention;

FIG. 3 is a block diagram illustrating a system for reformatting contents in a wireless Internet site according to another embodiment of the present invention;

FIG. 4 is a flowchart illustrating a process routine for reformatting contents in a wireless Internet site according to one embodiment of the present invention;

FIG. 5 is a flowchart illustrating a process routine for reformatting contents in a wireless Internet site according to another embodiment of the present invention; and

FIG. 6 is a flowchart illustrating a process routine for reformatting contents in a wireless Internet site according to another embodiment of the present invention.

### DETAILED DESCRIPTION OF THE PREFERRED EMBODIMENT

Reference will now be made in detail to the preferred embodiments of the present invention.

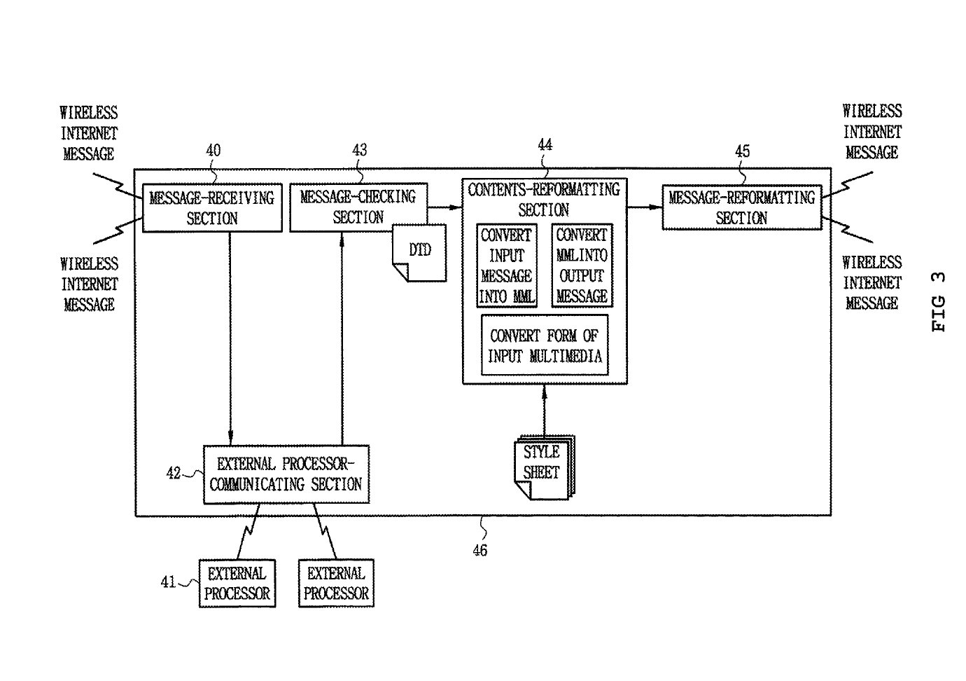

FIGS. 2 and 3 illustrate block diagrams of a system for reformatting contents in a wireless Internet site according to different embodiments of the present invention.

Referring to FIGS. 2 and 3, there is shown a system 36, 46 for reformatting contents in a wireless Internet site according to the present invention including a message-receiving section 30, 40, an external processor 31, 41, an external processor-communicating section 32, 42, a message-checking section 33, 43, a contents-reformatting section 34, 44 and a message-transmitting section 35, 45. The message-receiving section 30, 40 acts to receive a message from the wireless terminal and check a language supported by the wireless terminal from the received message to store it therein. The external processor 31, 41 acts to provide contents over a wireless Internet. The external processor-communicating section 32, 42 acts to determine which Web page has been called from the message received by the message-receiving section 30, 40 to call a corresponding external processor 31, 41 and to allow contents data processed by and outputted from the called external processor to be received therethrough. The message-checking section 33, 43 functions to determine whether or not the contents data inputted thereto through the external process-communicating section 32, 42 from the external processor 31, 41 is configured to conform to a meta tag as a pre-defined language. The contents-reformatting section 34, 44 functions to convert the contents data into a language supported by the wireless terminal if it determined that the contents data is configured with the meta tag. And, the message-transmitting section 35, 45 serves to transmit converted contents applied thereto from the contents-reformatting section 34, 44 to the wireless terminal.

The contents-reformatting section 34, 44 further includes a tag-converting module for converting an input message identified by the message-checking section into contents of an XML-based meta tag (MML) type and then converting the converted MML-type contents into contents of type which can be recognized by the wireless terminal, and a language-translating module for analyzing a header portion of the contents and a header portion of the message requested by the wireless terminal to identify a national language used to draw up the contents and for translating the contents into a national language supported by the wireless terminal according to a result of the identification of the used national language.

Also, the contents-reformatting section 34, 44 further includes a tag-converting module for converting an input message identified by the message-checking section into contents of an XML-based meta tag (MML) type and then converting the converted MML-type contents into contents of type which can be recognized by the wireless terminal, and a multimedia-converting module for identifying a used multimedia form using the header portion of the request message of the wireless terminal and converting multimedia contents inputted to the contents-reformatting section 44 from the external processor 41 into a multimedia form supported by the wireless terminal according to a result of the identification of the used multimedia form.

Also, the contents-reformatting section 34, 44 further includes a tag-converting module for converting an input message identified by the message-checking section into contents of an XML-based meta tag (MML) type and then converting the converted MML-type contents into contents of type which can be recognized by the wireless terminal, a language-translating module for analyzing a header portion of the contents and a header portion of a request message of the wireless terminal to identify a national language used to draw up the contents and for translating the contents into a national language supported by the wireless terminal according to a result of the identification of the used national language, and a multimedia-converting module for identifying a used multimedia form using the header portion of the request message of the wireless terminal and converting multimedia contents inputted to the contents-reformatting section 44 from the external processor 41 into a multimedia form supported by the wireless terminal according to a result of the identification of the used multimedia form.

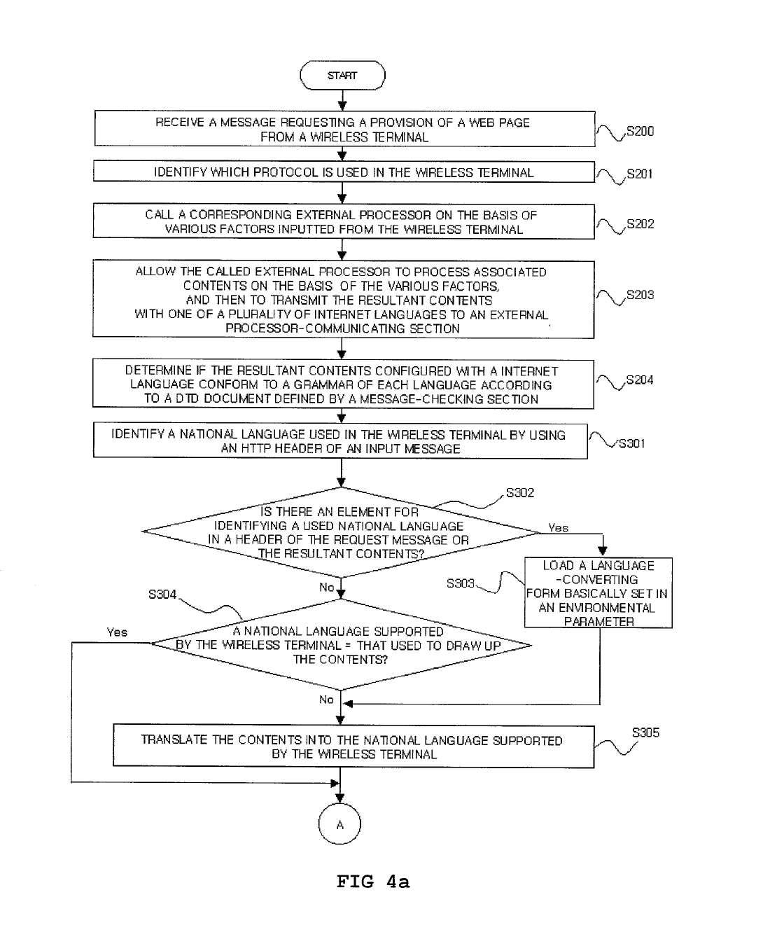

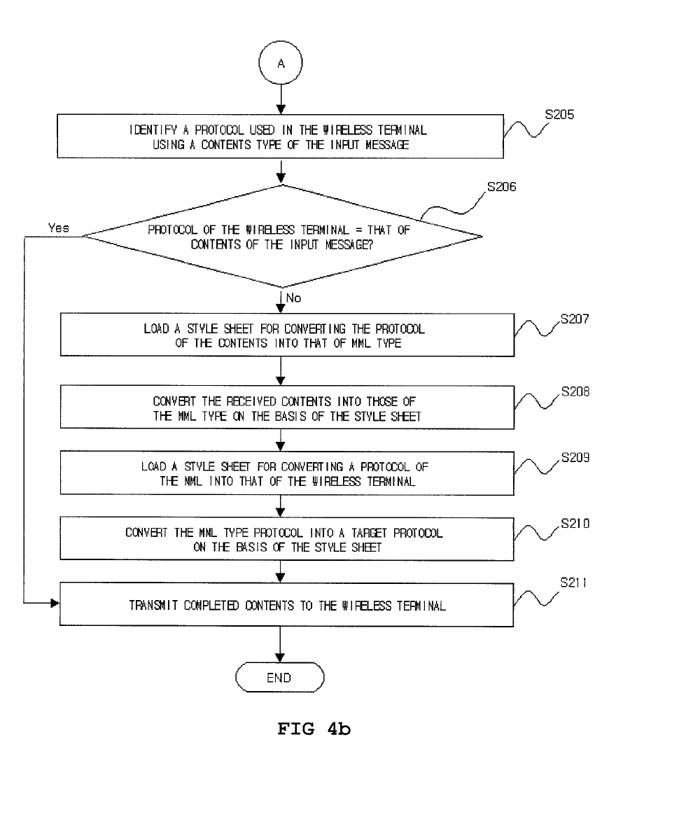

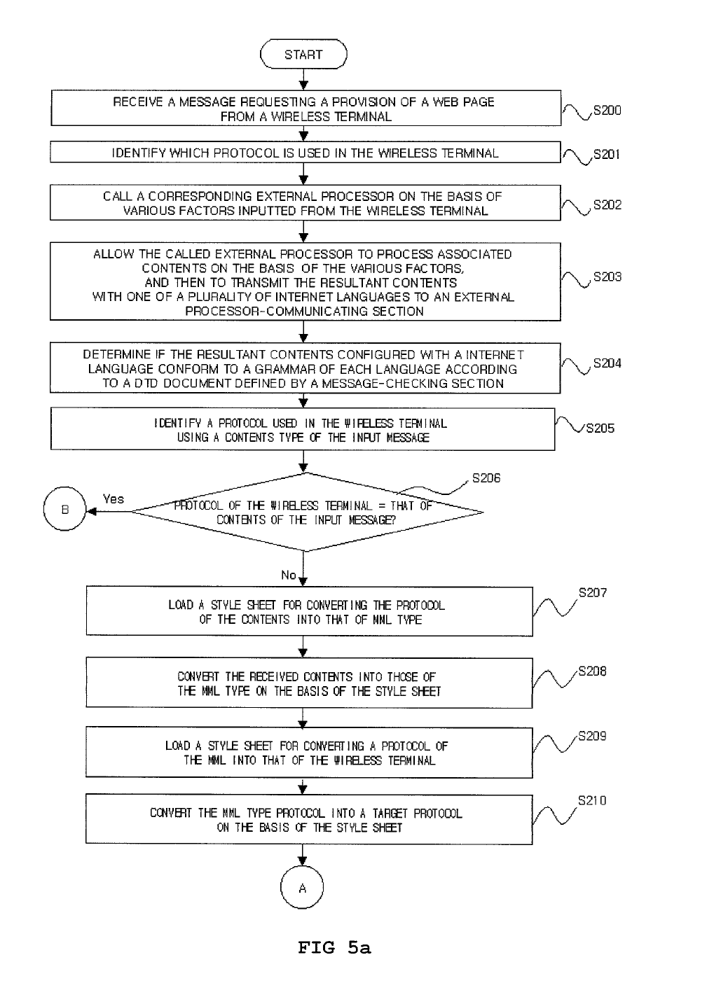

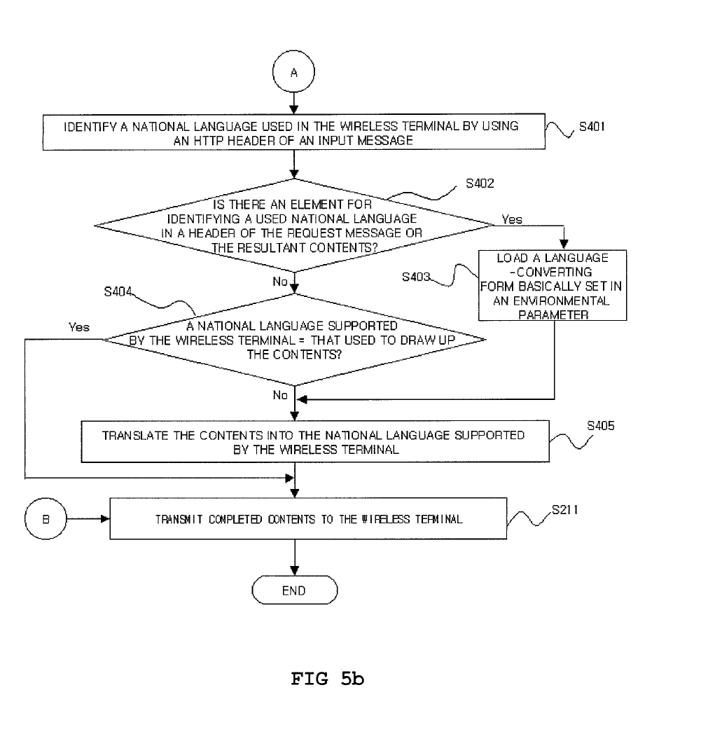

In the meantime, FIGS. 4 and 5 illustrate flowcharts of process routines for reformatting contents in a wireless Internet site according to an embodiment of the present invention in which the contents-reformatting section incorporates a language-translating module.

Referring to FIG. 4, first, at step S200, a user requests a contents-reformatting system 36 according to the present invention embedded in an Internet server to provide a Web page to him/her through a wireless terminal. At step S201, the Internet server identifies which protocol is used in the wireless terminal. At step S202, the Internet server calls a corresponding external processor 31 on the basis of various factors inputted thereto from the wireless terminal. At subsequent step S203, the called corresponding external processor 31 processes associated contents on the basis of the various factors inputted to the contents-reformatting system 36 from the wireless terminal, and then configures the resultant contents with one of a plurality of Internet languages for transmission to the external processor-communicating section 32. Subsequently, at step S204, when the message-checking section 33 receives the resultant contents configured with a Internet language from the called external processor 31 through the external processor-communicating section 32, the Internet server determines whether or not the received resultant contents conforms to a grammar of each language according to a DTD document defined by the message-checking section 33. At step S301, the Internet server identifies a national language used in the wireless terminal by using an HTTP header of an input message of the wireless terminal. Then, the program proceeds to step S302 at which the Internet server determines whether or not there is an element for identifying a national language used to draw up the message requested by the wireless terminal or the received resultant contents in a header of the request message of the wireless terminal or a header of the received resultant contents. If it is determined at S302 that there is not an element for identifying the used national language, the program proceeds to step S303 where the Internet sever loads a language-converting form basically set in an environmental parameter. On the other hand, if it is determined at S302 that there is an element for identifying the used national language, the program proceeds to step S304 where the Internet server determines whether or not a national language supported by the wireless terminal is identical with a national language used to draw up the contents. If it is determined at step S304 that the national language supported by the wireless terminal is not identical with the national language used to draw up the contents, the program proceeds to step S305 where the Internet server translates the contents into a national language supported by the wireless terminal. On the other hand, if it is determined at step S304 that the national language supported by the wireless terminal is identical with the national language used to draw up the contents, the program proceeds to step S205 where the Internet server identifies a protocol used in the wireless terminal using a contents type of the input message. Then, the program proceeds to step S206 where the Internet server determines whether or not a protocol of the wireless terminal is identical with that of contents of the input message. If it is determined at step S206 that the protocol of the wireless terminal is not identical with that of contents of the input message, the program proceeds to step S207 where the Internet server loads a style sheet for converting the protocol of the contents into that of MML type. Subsequently, at step S208, the Internet server converts the received contents into those of the MML type on the basis of the style sheet, and then, at step S209, loads a style sheet for converting a protocol of the MML type into that of the wireless terminal. At subsequent step S210, the Internet server converts the protocol of the MML type into a target protocol on the basis of the style sheet. Finally, at step S211, the Internet server transmits completed contents to the wireless terminal requesting the provision of the Web page. If, on the other hand, it is determined at step S206 that the protocol of the wireless terminal is identical with that of contents of the input message, the program also proceeds to step S207 where the Internet server transmits completed contents to the wireless terminal requesting the provision of the Web page. Thus, the contents reformatting routine is concluded.

Also, referring to FIG. 5, first, at step S200, a user requests a contents-reformatting system 36 according to the present invention embedded in an Internet server to provide a Web page to him/her through a wireless terminal. At step S201, the Internet server identifies which protocol is used in the wireless terminal. At step S202, the Internet server calls a corresponding external processor 31 on the basis of various factors inputted thereto from the wireless terminal. At subsequent step S203, the called corresponding external processor 31 processes associated contents on the basis of the various factors inputted to the contents-reformatting system 36 from the wireless terminal, and then configures the resultant contents with one of a plurality of Internet languages for transmission to the external processor-communicating section 32. Subsequently, at step S204, when the message-checking section 33 receives the resultant contents configured with a Internet language from the called external processor 31 through the external processor-communicating section 32, the Internet server determines whether or not the received resultant contents conform to a grammar of each language according to a DTD document defined by the message-checking section 33. At step S205, the Internet server identifies a protocol used in the wireless terminal using a contents type of an input message of the wireless terminal. Then, the program proceeds to step S206 where the Internet server determines whether or not a protocol of the wireless terminal is identical with that of contents of the input message. If it is determined at step S206 that the protocol of the wireless terminal is not identical with that of contents of the input message, the program proceeds to step S207 where the Internet server loads a style sheet for converting the protocol of the contents into that of MML type. Subsequently, at step S208, the Internet server converts the received contents into those of the MML type on the basis of the style sheet, and then, at step S209, loads a style sheet for converting a protocol of the MML into that of the wireless terminal. At subsequent step S210, the Internet server converts the MML protocol into a target protocol on the basis of the style sheet. At step S401, the Internet server identifies a national language used in the wireless terminal by using an HTTP header of the input message. Then, the program proceeds to step S402 at which the Internet server determines whether or not there is an element for identifying a national language used to draw up the message requested by the wireless terminal or the received resultant contents in a header of the request message of the wireless terminal or a header of the received resultant contents. If it is determined at S402 that there is not an element for identifying the used national language, the program proceeds to step S403 where the Internet sever loads a language-converting form basically set in an environmental parameter. On the other hand, if it is determined at S402 that there is an element for identifying the used national language, the program proceeds to step S404 where the Internet server determines whether or not a national language supported by the wireless terminal is identical with a national language used to draw up the contents. If it is determined at step S404 that the national language supported by the wireless terminal is not identical with the national language used to draw up the contents, the program proceeds to step S405 where the Internet server translates the contents into a national language supported by the wireless terminal, and then, at step S211, transmits completed contents to the wireless terminal requesting the provision of the Web page. Thus, the contents reformatting routine is concluded. On the other hand, if it is determined at step S404 that the national language supported by the wireless terminal is identical with the national language used to draw up the contents, the program also proceeds to step S211 where the Internet server transmits completed contents to the wireless terminal requesting the provision of the Web page. If, on the other hand, it is determined at step S206 that the protocol of the wireless terminal is identical with that of contents of the input message, the program also proceeds to step S211 where the Internet server transmits completed contents to the wireless terminal requesting the provision of the Web page. Thus, the contents reformatting routine is concluded.

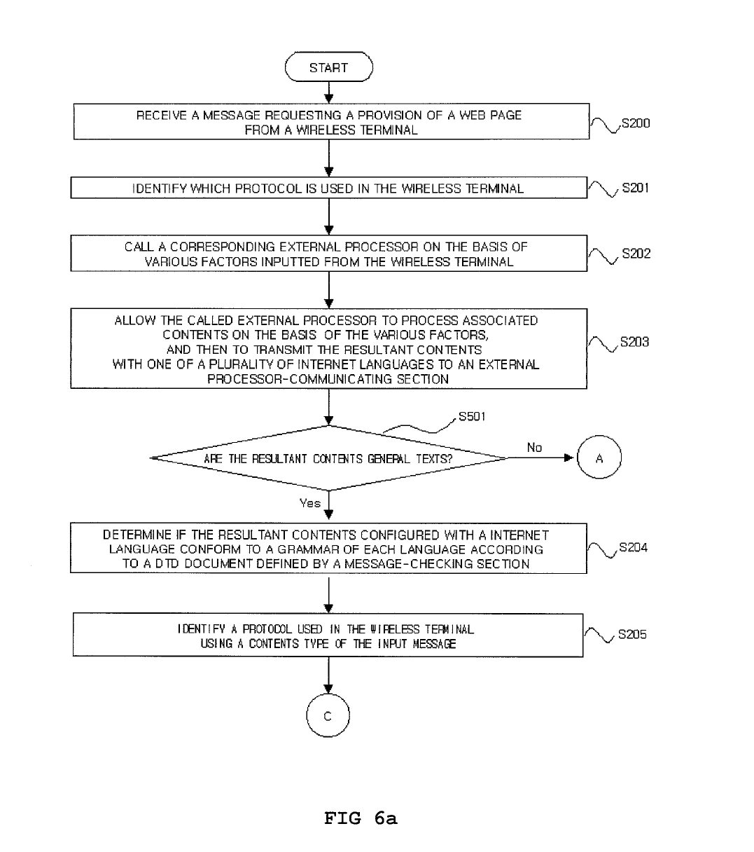

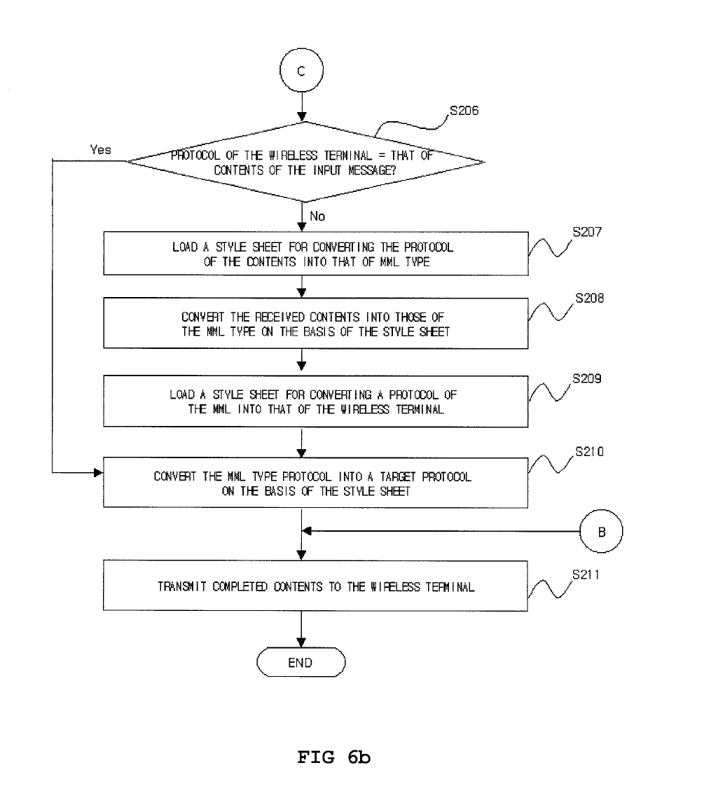

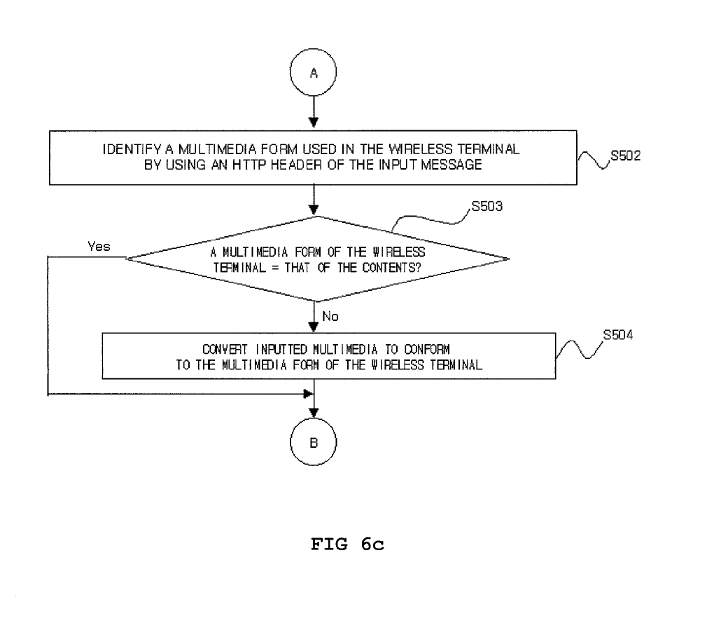

Also, FIG. 6 illustrates a flowchart of a process routine for reformatting contents in a wireless Internet site according to another embodiment of the present invention in which the contents-reformatting section incorporates a multimedia-converting module.

Referring to FIG. 6, first, at step S200, a user requests a contents-reformatting system 46 according to the present invention embedded in an Internet server to provide a Web page to him/her through a wireless terminal. At step S201, the Internet server identifies which protocol is used in the wireless terminal. At step S202, the Internet server calls a corresponding external processor 41 on the basis of various factors inputted thereto from the wireless terminal. At subsequent step S203, the called corresponding external processor 41 processes associated contents on the basis of the various factors inputted to the contents-reformatting system 46 from the wireless terminal, and then configures the resultant contents with one of a plurality of Internet languages for transmission to the external processor-communicating section 42. Subsequently, at step S501, the Internet server determines whether or not the resultant contents configured with a language that have been transmitted to the external processor-communicating section 42 are general texts. If it is determined at step S501 that the answer is NO, the program proceeds to step S502 where the Internet server identifies a multimedia form used in the wireless terminal by using an HTTP header of an input message of the wireless terminal. Then, the program proceeds to step S503 where the Internet server determines whether or not a multimedia form of the wireless terminal is identical with that of the resultant contents. If it is determined at step S503 that the answer is NO, the program proceeds to step S504 where the Internet server converts multimedia contents inputted to the message-checking section 43 from the external processor 41 to conform to a multimedia form of the wireless terminal. If, on the other hand, it is determined at step S501 that the answer is YES, that is, the resultant contents configured with a language that have been transmitted to the external processor-communicating section 42 are general texts, the program proceeds to step S204 where the message-checking section 43 receives the resultant contents configured with a Internet language from the called external processor 41 through the external processor-communicating section 42, the Internet server determines whether or not the received resultant contents conform to a grammar of each language according to a DTD document defined by the message-checking section 43. At step S205, the Internet server identifies a protocol used in the wireless terminal using a contents type of the input message. Then, the program proceeds to step S206 where the Internet server determines whether or not protocol of the wireless terminal is identical with that of contents of the input message. If it is determined at step S206 that the protocol of the wireless terminal is not identical with that of the contents, the program proceeds to step S207 where the Internet server loads a style sheet for converting a protocol of the contents into that of MML type. Subsequently, at step S208, the Internet server converts the received contents into those of the MML type on the basis of the style sheet, and then, at step S209, loads a style sheet for converting a protocol of the MML into that of the wireless terminal. At subsequent step S210, the Internet server converts the MML type protocol into a target protocol on the basis of the style sheet. Then, at final step S211, the Internet server transmits completed contents to the wireless terminal requesting the provision of the Web page. Thus, the contents reformatting routine is concluded. If, on the other hand, it is determined at step S206 that the protocol of the wireless terminal is identical with that of contents of the input message, the program also proceeds to step S211 where the Internet server transmits completed contents to the wireless terminal requesting the provision of the Web page. Thus, the contents reformatting routine is concluded.

In the meantime, according to another embodiment of the contents reformatting method of the present invention, the step S203 of the contents reformatting routine as shown in FIGS. 4 and 5 further may include the steps of: determining whether or not the resultant contents configured with a language that have been transmitted to the external processor-communicating section are general texts (S501); identifying a multimedia form used in the wireless terminal by using an HTTP header of an input message from the wireless terminal if it is determined that the resultant contents transmitted to the external processor-communicating section are not general texts (S502); determining whether or not a multimedia form of the wireless terminal is identical with that of the resultant contents (S503); converting multimedia contents inputted to the message-checking section from the external processor to conform to a multimedia form of the wireless terminal if it is determined that the multimedia form of the wireless terminal is not identical with that of the resultant contents (S504).

Korean patent application No. 43,569 filed on Jul. 28, 2000 by this applicant and not published yet, and Korean patent application No. 60863 filed on October 17 and which claims a priority right on the patent application No. 43,569 disclose a system and method for reformatting contents in a wireless Internet site in which an XML-based meta tag is specified in consideration of an Internet site-building tag according to each wireless protocol, and, on the basis of this, a wireless Internet site made with a wireless Internet or a meta tag is converted to conform to the form of a proper tag according to the type of a browser of a wireless terminal which had accessed the wireless Internet site and then is transmitted to the wireless terminal.

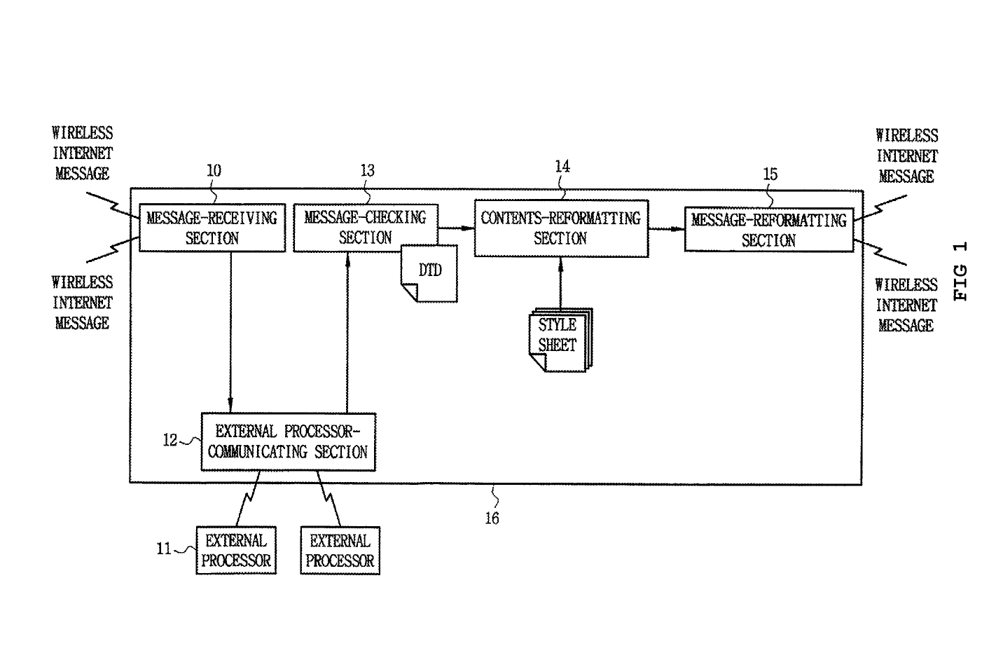

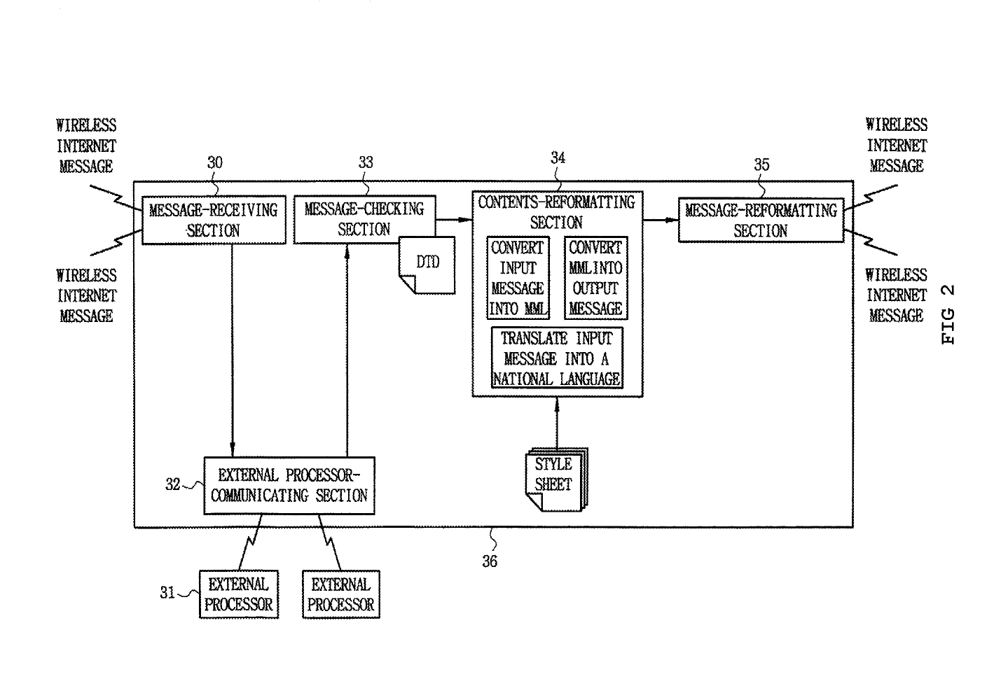

FIG. 1 is a block diagram illustrating a system for reformatting contents in a wireless Internet site according to the present invention.

Referring FIG. 1, there is shown the contents reformatting system 16 according to the patent application Nos. 43569 and 60863 including a message-receiving section 10, an external processor 11, an external processor-communicating section 12, a message-checking section 13, a contents-reformatting section 14 and a message-transmitting section 15. The message-receiving section 10 acts to receive a message from the wireless terminal and check a language supported by the wireless terminal from the received message to store it therein. The external processor 11 acts to provide contents over a wireless Internet. The external processor-communicating section 12 acts to determine which Web page has been called from the message received by the message-receiving section 10 to call a corresponding external processor 11 and to allow contents data processed by and outputted from the called external processor to be received therethrough. The message-checking section 13 functions to determine whether or not the contents data inputted thereto through the external process-communicating section 12 from the external processor 11 is configured to conform to a wireless Internet or a meta tag as a pre-defined language. The contents-reformatting section 14 functions to convert the contents data into a language supported by the wireless terminal if it is determined that the contents data is configured with the wireless Internet or the meta tag. And, the message-transmitting section 15 serves to transmit converted contents applied thereto from the contents-reformatting section 14 to the wireless terminal.

Also, the contents-reformatting section 14 includes a portion for converting an input message identified by the message-checking section into contents of an XML-based meta tag (MML) type and a portion for converting the converted MML-type contents into contents of type which can be recognized by the wireless terminal.

Accordingly, the contents-reformatting section 14 converts the contents defined by an XML-based meta tag which is inputted thereto from the message-checking section 13 to conform to a target protocol on the basis of a style sheet. By means of this process, contents conforming to a language that can be recognized by a browser of the wireless terminal are obtained as a resultant product. Consequently, the message-transmitting section 15 transmits the finally obtained contents to the wireless terminal which had requested a provision of contents from the contents-reformatting section 16.

The technologies of the above-mentioned Korean patent application Nos. 43,569 and 60,863 can convert a tag used to draw up contents of a wireless Internet site into a proper tag according to the type of a browser of a wireless terminal which accesses the wireless Internet site to transmit it to the wireless terminal. However, in the case a national language used to draw up details of the contents is different from that supported by the wireless terminal, or multimedia information of the contents is configured with a multimedia form that cannot be transmitted to the wireless terminal, a language obstacle causes both a free movement of contents between nations and a search of foreign wireless Internet sites to be interrupted, and it is difficult to utilize multimedia information such as graphic images, moving images, sound and the like. Thus, in consideration of these problems, the contents reformatting system according to FIGS. 2 and 3 and the contents reformatting method according to FIGS. 4, 5 and 6 has been proposed.

To help to understand the process routine of the contents reformatting method according to the another invention, a function for each constituent element of the contents reformatting system 36, 46 shown in FIGS. 2 and 3 will be described hereinafter.

This system 36, 46 is generally installed in an Internet server, and the message-receiving section 30, 40 first receives a message from a wireless terminal such as a cellular phone, a PCS phone and the like.

At this time, the message includes information about which Web page is called by the wireless terminal, information about a browser built into the wireless terminal and information about factors sent to the requested Web page, for example, factors sent with Query String and Form Parameter.

For reference, the Query String refers to a method of transferring factors between Web pages in which “?” is attached to the end of an address of a Web page. For example, in a Web page address of “http://www.where.com/list.htm?page=1&user=anybody”, “page” and “user” stated in back of “?” denote the names of factors, and “1” and “anybody” denote the values of each factor. As illustrated above, when there are a number of factors, each factor is separated from the next by a symbol of “&”.

Also, the Form Parameter refers to another method of transferring factors between Web pages which uses an element of “form”, and provides a blank for text information to be inputted like in a case of a member subscription, or a means in which a user can directly input desired information like in a case of a selection of one from among several optional items, etc., to transfer an inputted value as a factor.

When transferring the factor from the Form to a Web page, a GET or POST scheme is used. The above-mentioned Query String is a kind of the GET scheme. The POST scheme is generally used to transfer a long factor value to a Web page.

Also, in terms of characteristics of an Http protocol, a header portion of the Http protocol transferred along with a message includes the name of a browser, or information indicating the kind of a language supported by a wireless terminal such as a Mime type supported by the browser. The message-receiving section of the contents reformatting system of the present invention receives a message from the wireless terminal, and, on the basis of the header portion, checks a language supported by the wireless terminal to store therein.

A currently used wireless Internet language can be largely classified into WML, HDML, mHTML, sHTML, cHTML, etc., and a user can recognize a language supported by a wireless terminal through the header portion of the Http protocol.

For reference, a wireless Internet uses the same protocol as that used during the transmission and reception of data between a server and a user on the Web. At this time, transferred data is divided into a header portion and a body portion. The header portion includes the type (Mime) of data, the kind of a browser, an IP address of the user, etc. The body includes an actual data.

Next, the external processor-communicating section 32, 42 exchanges information with the external processor 31, 41 as an actual module for producing contents over a wireless Internet.

That is, the external processor-communicating section 32, 42 acts to determine which Web page has been called from the message received by the message-receiving section 30, 40 to call a corresponding external processor 31, 41 and to allow resultant contents processed by and outputted from the called external processor to be received by the message-checking section 33 therethrough.

For reference, the external processor 31, 41 can be regarded as a program for actually constituting contents, which is configured with the form of CGI (Common Gateway Interface) used in an existing Web.

Namely, an existing processor functions to perform an operation such as an access to a database like in an existing Web, and then converts resultant contents obtained through the access operation into an HTML language to conform to a configuration of a screen. But, the external processor 31, 41 is different from the existing processor only in that it converts the resultant contents to conform to a pre-defined language for reformatting contents, but not the HTML language.

Also, the external processor 31, 41 may serve to collect a specific data from a database according to the properties of a Web page, and simply transfer pre-written information to the message-checking section 33.

At this time, when the message-receiving section 30, 40 receives a message including factors from a wireless terminal, it transfers the received message along with the factors to the external processor 31, 41. Then, the external processor 31, 41 performs its intrinsic function, and then configures the resultant contents obtained according to the performance of the intrinsic function to conform to a pre-defined contents-reformatting language for transmission to the external processor-communicating section 32.

Next, the message-checking section 33, 43 functions to determine whether or not the contents information inputted thereto through the external process-communicating section 32, 42 from the external processor 31, 41 is configured to conform to a meta tag as a pre-defined language.

Namely, before the contents transmitted to the message-checking section 33, 43 from the external processor 31, 41 through the external processor-communicating section 32, 42 are converted by the contents-reformatting section 33, 34, they undergo a procedure for determining whether or not they have been configured correctly. At this time, the determination procedure is performed by determining where or not the contents are configured to conform to a pre-defined DTD.

If the contents are configured improperly, an error message can be immediately outputted without conversion of the contents by the contents-reformatting section 33, 43.

Next, the contents-reformatting section 34, 44 functions to convert the contents to conform to a language supported by the wireless terminal if the contents are configured with the meta tag as the pre-defined language.

That is, when the contents-reformatting section 34, 44 is supplied with the contents configured with the pre-defined language, it sets a target language according to a pre-searched language supported by the wireless terminal and converts the contents to conform to the target language on the basis of a style sheet according to a pre-defined language.

The style sheet is defined to conform to an XSLT format as a subset of an XML.

That is, the style sheet refers to a document that defines if each tag will be converted into a tag of which form finally with respect to a meta tag defined to conform to the XML.

Finally, the message-transmitting section 35, 45 serves to transmit the contents applied thereto from the contents-reformatting section 34, 44 to the wireless terminal. Namely, the contents-reformatting section 34, 44 applies the contents to the message-transmitting section 35, 45 which, in turn, transmits the contents to the wireless terminal which had requested a provision of the contents information.

An example of the contents-reformatting method to be implemented by the contents-reformatting system consisting of the constituent elements having the above-mentioned functions will be described hereinafter with reference to FIG. 4.

Referring to FIG. 4, first, while a wireless Internet user searches a community site, he/she reads a new official announcement inserted on a bulletin board of a community with which he/she has registered as a member, and then requests the contents-reformatting system 36, 46 embedded in an Internet server managing the community site, to show him/her a second Web page of the official announcement through a wireless terminal (S200).

When the message-receiving section 30, 40 positioned in a front end of the contents-reformatting section 36,46 receives a request signal from the wireless terminal, it identifies which language is supported by the wireless terminal of the user (S201). In order to identify the type of a language supported by the wireless terminal, first, it is required that the message-receiving section 10 analyze a message sent by a browser installed in the wireless terminal, and then extract the type of the browser and the type of a MIME from information included in a header portion of the message.

For example, in Korea, when the information extracted from the header portion includes a subscriber to a particular telecom service 011, the wireless terminal is supported by WML, when the information includes a subscriber to another telecom service 017 or 019, the wireless terminal is supported by HDML, when the information includes a 016 or 018 subscriber, the wireless terminal is supported by mHTML, when the information includes a SAMSUNG Internet phone (Trademark of SAMSUNG co., ltd.) subscriber, the wireless terminal is supported by sHTML.

As described above, when the user requests the contents-reformatting system 36, 46 to show him/her the second Web page of the official announcement, the message-receiving section 30, 40 receives the request message from the wireless terminal of the user, and then identifies the protocol type of the wireless terminal. After that, the message-receiving section 30, 40 transmits a certain signal to the external processor 31, 41 through the external processor-communicating section 32, 42 to call the external processor 31, 41 so that the requested information is transmitted to the message-receiving section 30, 40 (S202).

That is, the external processor-communicating section 32, 42 transmits a factor of the requested second Web page to the external processor 31, 41, and then receives a list of the official announcement in a pre-written process from the external processor 31, 41.

To describe this process in more detail, the called external processor 31, 41 fetches a title list of the official announcement from a database (not shown). At this time, assuming that 10 lists per page are displayed at a time on a screen, lists including from eleventh list to twentieth list are fetched from the database on the basis of a factor of a second Web page, and then are arranged according to a pre-defined screen size. Subsequently, the external processor 31, 41 draws up a contents document with the form of a pre-defined meta tag to transfer its resultant contents to the message-checking section 33, 43 through the external processor-communicating section 32, 42 (S203).

In the meantime, the contents document written with he form of the meta tag is received by the message-checking section 33, 43 which determines whether or not the received resultant contents are drawn up correctly to conform to a grammar of the meta tag language according to a DTD document defined by the message-checking section 33. If the message-checking section 33, 43 determines that the resultant contents are drawn up with the incorrect form of the meta tag, it generates an error message. On the other hand, if the message-checking section 33, 43 determines that the resultant contents are drawn up with the correct form of the meta tag, it transfers the written contents document to the contents-reformatting section 34 (S204).

Then, the contents-reformatting section 34, 44 performs a tag conversion process through a tag-converting module for converting an input message into contents of an XML-based meta tag (MML), and then converts the converted MML type contents into a target output message (S204-210).

At this time, the content-reformatting section 33, 34 converts the contents configured with the XML-based meta tag applied thereto from the message-checking section 33, 43 to conform to a target protocol on the basis of a corresponding style sheet loaded at a previous step.

As a result, the contents-reformatting section 34, 44 generates the resultant contents configured to conform to a language recognizable by a browser of the wireless terminal which is applied to the message-transmitting section 35, 45. At this time, the message-transmitting section 35, 45 transmits the finally obtained contents to the wireless terminal first requesting the provision of a Web page (S211). Thus, a user can view corresponding lists of the second Web page of the official announcement through a screen of his/her wireless terminal.

The function of the contents-reformatting section 34 including a language-translating module will be described hereinafter in detail with reference to FIGS. 2, 4 and 5.

When factors are transmitted to the external processor 31 from the message-receiving section 30 through the external processor-communicating section, the external processor 31 performs an internal process operation such as an access to a database (DB), a statistical calculation, etc., and then converts the resultant contents to conform to one of a plurality of Internet languages such as WML, HDML, mHTML, sHTML, cHTML etc., for transmission to the message-checking section 33 through the external processor-communicating section 32 (S203).

When the message-checking section 33 receives the converted resultant contents from the external processor 31, it determines whether or not the received resultant contents conform to a grammar of each language according to a pre-defined DTD document (S204). At this time, if there occurs an error, the message-checking section 33 transmits an error message to the wireless terminal.

Next, the contents-reformatting section 34 analyzes a header portion of an input message to identify the type of a language used to draw up the contents (S205). The type of a language supported by the wireless terminal can be identified by analyzing the content of an Http header transmitted to the message-receiving section 30 from a browser embedded into the wireless terminal. Generally, the type of a language supported by the wireless terminal can be identified through the type of supportable contents or the name of the browser included in the content of the Http header.

That is, the contents-reformatting section 34 identifies the type of a protocol used to draw up the resultant contents from the external processor 31, and then compares the protocol supported by the wireless terminal with that used to draw up the contents (S206). If the protocol of wireless terminal is identical with that of the contents, the contents-reformatting section 34 applies the contents to the message-transmitting section 35 which, in turn, immediately transmits it to the wireless terminal. On the contrary, if the protocol of wireless terminal is not identical with that of the contents, the contents undergo a tag-converting process in the content-reformatting section 34.

The tag-converting process is divided into two processes, i.e., a process for converting the contents sent to the message-checking section 33 from the external processor 31 into contents of MML type, and a process for converting the converted contents of the MML type into contents of a type recognizable by the wireless terminal.

That is, in order to convert the contents sent to the message-checking section 33 from the external processor 31 into the contents of MML type, the contents-reformatting section 34 loads a style sheet for converting a protocol of the contents into that of MML type (S207, S208). Subsequently, the contents-reformatting section 34 loads a style sheet for converting the protocol of the MML type into the protocol of the wireless terminal to perform the tag-converting process (S209, S210).

Finally, the contents-reformatting section 34 transmits the completed contents to the wireless terminal requesting a provision of a desired Web page through the message-transmitting section 35 (S211).

At this time, the contents-reformatting section 34 also performs a process for analyzing a header portion of the contents and a header portion of the message requested by the wireless terminal to identify a national language used to draw up the contents and translating the contents into a national language supported by the wireless terminal according to a result of the identification of the used national language.

The above process for translating the contents into a national language supported by the wireless terminal is performed prior to a process for converting a wireless Internet language to conform to a language supported by the wireless terminal like in FIGS. 4a and 4b, or following a process for converting a wireless Internet language to conform to a language supported by the wireless terminal like in FIGS. 5a and 5b.

Referring to FIG. 4 or 5, the process for translating the contents into a national language supported by the wireless terminal undergoes the following steps.

First, when a contents object to be translated is transferred from the external processor 31 to the message-checking section 33 or the contents-reformatting section 34, it analyzes a header portion of the contents and a header portion of the request message from the wireless terminal to determines whether or not the contents needs translating.

That is, in the case of the contents, the contents-reformatting section 34 identifies the type of a national language used to draw up the contents by referring to a “charset” part in the header portion of the contents, and in the case of the request message, the contents-reformatting section 34 identifies the type of a national language supported by the wireless terminal by referring to “HTTP_ACCEPT_LANGUAGE” part in the header portion of the request message. At this time, if it is impossible to identify the corresponding information in even either case, a basic language-translating form set in an environmental parameter is used (S302,S303).

Through the use of the identified information, it is determined whether or not a national language conversion process is needed. If the national language supported by the wireless terminal is identical with the national language used to draw up the contents (S304), the contents-reformatting section 34 immediately transmits the contents sent from the external processor 31 to the wireless terminal through the message-transmitting section 35 without performing the national language conversion process. On the other hand, if the national language supported by the wireless terminal is not identical with the national language used to draw up the contents, the contents-reformatting section 34 translates the contents into a corresponding national language supported by the wireless terminal to transmit its resultant contents to the wireless terminal through the message-transmitting section 35 (S305).

In the meantime, the function of the contents-reformatting section 34 including a multimedia-converting module will be described hereinafter in detail with reference to FIGS. 3 and 6.

The contents-reformatting section 44 identifies the form of a multimedia used in the request message of the wireless terminal using the header portion of the input message or the request message of the wireless terminal and converts multimedia contents inputted to the contents-reformatting means from the external processor into a multimedia form recognizable by the wireless terminal according to a result of the identification of the used multimedia form.

Contents used in the wired or wireless Internet include text information as well as multimedia information such as graphic images, moving pictures, sound and the like. Accordingly, in the case that a wired Internet site and a wireless Internet site share and utilize the same multimedia information, or the size of the multimedia information is reduced to decrease data traffic, the multimedia information undergoes a multimedia conversion process to conform to a service desire. In particularly, as IMT-2000 improves a transmission rate of data in wireless networks, a moving picture service becomes possible. At this time, a process for converting wired or wireless moving picture contents into contents of type that can be recognized by terminals must necessarily be supported.

Accordingly, the contents-reformatting section 44 additionally includes a multimedia-converting module for properly converting the form of a multimedia. Here, the multimedia undergoes a multimedia conversion process apart from the case where contents includes a text.

Namely, as shown in FIG. 6, when contents called by the message-receiving section 40 is transferred to the contents-reformatting section 44 from the external processor 41, the called contents is divided into a text portion and a multimedia portion such as moving pictures (S203). Thus, the contents may be a text, a multimedia or other objects, and the text and multimedia undergo different conversion processes. For this reason, a process for determining whether the contents are texts or multimedia is required (S501). At this time, the contents-reformatting section 44 can identifies a multimedia form used to draw up the contents through the type of contents in a header portion of the transferred contents.

If the contents transferred to the contents-reformatting section 44 are texts, the contents undergo a contents meta tag conversion process in the contents-reformatting section 44 (S204-S210). On the other hand, if the contents are multimedia, in order to determine where or not multimedia form conversion process must be performed, the contents-reformatting section 44 refers to a pre-written multimedia form data that can be provided from the wireless terminal. At this time, the pre-written multimedia form data includes information about the USER-AGENT type according to each wireless terminal, the type and attribute that can be provided according to graphic images and moving pictures, etc., (S502).

If the multimedia form of the contents is different from that of the wireless terminal (S503), the contents undergo a corresponding multimedia form conversion process. In this process, an adjustment of the size and color of data or the contents, a conversion of the multimedia form, etc., are performed, and then the resultant contents are transmitted to the wireless terminal (S504). On the other hand, if the multimedia form of the contents is identical with from that of the wireless terminal (S503), the contents are immediately transmitted to the wireless terminal without undergoing the multimedia form conversion process (S504).

The above-mentioned multimedia conversion process can be performed in the case that only a multimedia-converting module is added to a tag-converting module as shown in FIGS. 3 and 6, as well as a multimedia-converting module along with a language-translating module is added to tag-converting module. In the multimedia conversion process of the latter case, the multimedia conversion process is added only to the tag-converting process and the language-translating process, and the remaining processes are equal to those shown in FIGS. 4 and 5.

As can be seen from the foregoing, according to the contents-reformatting system and method of the present invention, an XML-based meta tag is specified in consideration of an Internet site-building tag according to each wireless protocol, and, on the basis of this, a wireless Internet site made with a wireless Internet or a meta tag is converted to conform to the form of a proper tag according to the type of a browser of a wireless terminal which accesses the wireless Internet site, and then is transmitted to the wireless terminal. Further, a national language used to draw up the contents of the wireless Internet site is identified so that the contents from the identified national language are translated into a national language supported by a wireless terminal which accesses the wireless Internet site according to a result of an identification of the national language, in such a fashion that for example, the contents written with the Korean language is translated into the Japanese language, or the contents written with the English language is translated into the Korean language, etc., and then are transmitted to the wireless terminal. Accordingly, a user in Korea can use an I-Mode site of Japan or Web sites operated in the U.S. so that he/she is free from a language obstacle, and a contents sale between nations becomes possible.

Moreover, multimedia contents used in a wired or wireless Internet site is converted to conform to a multimedia service that can be recognized by a wireless terminal which accesses the wireless Internet site and then is transmitted to the wireless terminal so that a user can be, at more rapid transmission rate, supplied with multimedia information such as graphic images, moving pictures, sound, etc.

While this invention has been described in connection with what is presently considered to be the most practical and preferred embodiment, it is to be understood that the invention is not limited to the disclosed embodiment, but is intended to cover various modifications, variations or equivalents within the spirit and scope of the appended claims.

What is claimed is:

1. A system for reformatting contents in a wireless Internet site which converts the wireless Internet site to conform to the form of a proper tag according to the type of a browser of a wireless terminal which accesses the wireless Internet site for transmission to the wireless terminal, comprising:
a message-receiving means adapted to receive a message from the wireless terminal and check a language supported by the wireless terminal from the received message to store it therein;
an external processor adapted to provide contents over a wireless Internet;
an external processor-communicating means adapted to determine which Web page has been called from the received message to call a corresponding external processor and to allow contents data processed by and outputted from the called external processor to be received therethrough;
a message-checking means adapted to determine whether or not the contents data inputted thereto through the external processor-communicating means from the external processor is configured to conform to a meta tag as a pre-defined language;
a contents-reformatting means adapted to convert the contents data into a language supported by the wireless terminal if it is determined that the contents data is configured with the meta tag; and
a message-transmitting means adapted to transmit converted contents applied thereto from the contents-reformatting means to the wireless terminal.

2. The system according to claim 1 wherein the contents-reformatting means further comprises a tag-converting module adapted to convert an input message identified by the message-checking means into contents of an XML-based meta tag (MML) type and then convert the converted MML-type contents into contents of type which can be recognized by the wireless terminal, and a language-translating module adapted to analyze a header portion of the contents and a header portion of the message requested by the wireless terminal to identify a national language used to draw up the contents and translate the contents into a national language supported by the wireless terminal according to a result of the identification of the used national language.

3. The system according to claim 1 wherein the contents-reformatting means further comprises a tag-converting module adapted to convert an input message identified by the message-checking means into an XML-based meta tag (MML) type and then convert the converted MML-type contents into a contents type which can be recognized by the wireless terminal, and a multimedia-converting module adapted to identify a used multimedia form using the header portion of the request message of the wireless terminal and convert multimedia contents inputted to the contents-reformatting means from the external processor into a multimedia form supported by the wireless terminal according to a result of the identification of the used multimedia form.

4. The system according to claim 1 wherein the contents-reformatting means further comprises a tag-converting module adapted to convert an input message identified by the message-checking means into contents of an XML-based meta tag (MML) type and then convert the converted MML-type contents into contents of type which can be recognized by the wireless terminal, a language-translating module adapted to analyze a header portion of the contents and a header portion of the message requested by the wireless terminal to identify a used national language and translate the contents into a national language supported by the wireless terminal according to a result of the identification of the used national language, and a multimedia-converting module adapted to identify a used multimedia form using the header portion of the request message of the wireless terminal and convert multimedia contents inputted to the contents-reformatting means from the external processor into a multimedia form supported by the wireless terminal according to a result of the identification of the used multimedia form.

5. A method for reformatting contents in a wireless Internet site which converts the wireless Internet site to conform to the form of a proper tag according to the type of a browser of a wireless terminal which accesses the wireless Internet site for transmission to the wireless terminal, comprising the steps of:
receiving a message requesting a provision of a Web page from a wireless terminal;
identifying which protocol is used in the wireless terminal;
calling a corresponding external processor on the basis of various factors inputted to a contents-reformatting system from the wireless terminal;
allowing the called corresponding external processor to process associated contents on the basis of the various factors, and then to transmit the resultant contents with one of a plurality of Internet languages to an external processor-communicating means;
determining whether or not the resultant contents configured with a predetermined language that has been inputted to the message-checking means from the called external processor through the external processor-communicating means conforms to a grammar of each language according to a DTD document defined by a message-checking means when the resultant contents are a general text;
identifying a used protocol using a contents type of an input message applied to the message-checking means from the called external processor;
determining whether or not a protocol of the wireless terminal is identical with that of contents of the input message;
loading a style sheet for converting the protocol of the contents into that of MML type if it is determined that the protocol of the wireless terminal is not identical with that of contents of the input message;
converting the received contents into those of the MML type on the basis of the style sheet;
loading a style sheet for converting a protocol of the MML type into that of the wireless terminal;
converting the MML type protocol into a target protocol on the basis of the style sheet; and
transmitting completed contents to the wireless terminal requesting the provision of the Web page.

6. A method for reformatting contents in a wireless Internet site which converts the wireless Internet site into a proper language according to the type of a browser of a wireless terminal which had accessed the wireless Internet site for transmission to the wireless terminal, comprising the steps of:
receiving a message requesting a provision of a Web page from a wireless terminal;
identifying which protocol is used in the wireless terminal;
calling a corresponding external processor on the basis of various factors inputted to a contents-reformatting system from the wireless terminal;
allowing the called corresponding external processor to process associated contents on the basis of the various factors, and then to transmit the resultant contents with one of a plurality of Internet languages to an external processor-communicating means;
determining whether or not the resultant contents configured with a Internet language conform to a grammar of each language according to a DTD document defined by the message-checking means when the message-checking means receives the resultant contents from the called external processor through the external processor-communicating means;
identifying a national language used in the wireless terminal by using an HTTP header of an input message of the wireless terminal;
determining whether or not there is an element for identifying a national language used to draw up the message requested by the wireless terminal or the received resultant contents in a header of the request message of the wireless terminal or a header of the received resultant contents;
loading a language-converting form basically set in an environmental parameter if it is determined that there is not an element for identifying the used national language;
determining whether or not a national language supported by the wireless terminal is identical with that used to draw up the contents if it is determined that there is an element for identifying the used national language;
translating the contents into a national language supported by the wireless terminal if it is determined that the national language supported by the wireless terminal is not identical with that used to draw up the contents;
identifying a protocol used in the wireless terminal using a contents type of the input message if it is determined that the national language supported by the wireless terminal is identical with that used to draw up the contents;
determining whether or not a protocol of the wireless terminal is identical with that of contents of the input message;
loading a style sheet for converting the protocol of the contents into that of MML type if it is determined that the protocol of the wireless terminal is not identical with that of contents of the input message;
converting the received contents into those of the MML type on the basis of the style sheet;
loading a style sheet for converting a protocol of the MML type into that of the wireless terminal;
converting the MML type protocol into a target protocol on the basis of the style sheet; and
transmitting completed contents to the wireless terminal requesting the provision of the Web page.

7. A method for reformatting contents in a wireless Internet site which converts the wireless Internet site into a proper language according to the type of a browser of a wireless terminal which had accessed the wireless Internet site for transmission to the wireless terminal, comprising the steps of:
receiving a message requesting a provision of a Web page from a wireless terminal;
identifying which protocol is used in the wireless terminal;
calling a corresponding external processor on the basis of various factors inputted to a contents-reformatting system from the wireless terminal;
allowing the called corresponding external processor to process associated contents on the basis of the various factors, and then to transmit the resultant contents with one of a plurality of Internet languages to an external processor-communicating means;
determining whether or not the resultant contents configured with a Internet language conforms to a grammar of each language according to a DTD document defined by the message-checking means when the message-checking means receives the resultant contents from the called external processor through the external processor-communicating means;
identifying a protocol used in the wireless terminal using a contents type of an input message of the wireless terminal;
determining whether or not a protocol of the wireless terminal is identical with that of contents of the input message;
loading a style sheet for converting the protocol of the contents into that of MML type if it is determined that the protocol of the wireless terminal is not identical with that of contents of the input message;
converting the received contents into the those of MML type on the basis of the style sheet;
loading a style sheet for converting a protocol of the MML type into that of the wireless terminal;
converting the MML type protocol into a target protocol on the basis of the style sheet;
identifying a national language used in the wireless terminal by using an HTTP header of the input message;
determining whether or not there is an element for identifying a national language used to draw up the message requested by the wireless terminal or the received resultant contents in a header of the request message of the wireless terminal or a header of the received resultant contents;
loading a language-converting form basically set in an environmental parameter if it is determined that there is not an element for identifying the used national language;
determining whether or not a national language supported by the wireless terminal is identical with that used to draw up the contents if it is determined that there is an element for identifying the used national language;
translating the contents into a national language supported by the wireless terminal if it is determined that the national language supported by the wireless terminal is not identical with that used to draw up the contents; and
transmitting completed contents to the wireless terminal requesting the provision of the Web page if it is determined that the national language supported by the wireless terminal is identical with that used to draw up the contents.

8. The method according to any one of claims 5 to 7 wherein the step of allowing the called corresponding external processor to process associated contents, and then to transmit the resultant contents with one of a plurality of Internet languages to the external processor-communicating means further comprises the steps of:
determining whether or not the resultant contents configured with a language that have been transmitted to the external processor-communicating means are general texts;
identifying a multimedia form used in the wireless terminal by using an HTTP header of an input message of the wireless terminal if it is determined that the resultant contents transmitted to the external processor-communicating means are not general texts;
determining whether or not a multimedia form of the wireless terminal is identical with that of the resultant contents;
converting multimedia contents inputted to the message-checking means from the external processor to conform to a multimedia form of the wireless terminal if it is determined that the multimedia form of the wireless terminal is not identical with that of the resultant contents.
